(19) United States
(12) Patent Application Publication
(10) Pub. No.: US 2021/0251430 A1
(43) Pub. Date: Aug. 19, 2021

(54) Cooking Implement Handle

(71) Applicant: Asim Mohammed AZAM, Bradford (GB)

(72) Inventor: Asim Mohammed AZAM, Bradford (GB)

(21) Appl. No.: 17/169,426

(22) Filed: Feb. 6, 2021

Related U.S. Application Data
(60) Provisional application No. 62/977,182, filed on Feb. 15, 2020.

(51) Int. Cl. A47J 45/07; B25G 1/06; B25G 3/38; A47J 37/10; A47J 43/18

(52) U.S. Cl. CPC A47J 45/075; B25G 1/06; A47J 45/071; A47J 37/101; A47J 43/18; B25G 3/38

(57) ABSTRACT

An apparatus including a cooking implement having a first surface. A first locking mechanism and a second locking mechanism, the first locking mechanism provided along the first surface of the cooking implement. A first handle support bar comprising a first end and a second end, the first end of the first handle support bar pivotally attached to the first locking mechanism. A second handle support bar comprising a first end and a second end, the first end of the second handle support bar pivotally attached to the second locking mechanism. The first handle support bar is removably lockable in one or more positions.

### PRIORITY CLAIMS

This non-provisional patent application claims the benefit of U.S. Provisional Application No. filed on Feb. 15, 2020, the entirety of which is incorporated herein by reference.

### FIELD

The present disclosure relates to adjustable handle mechanisms. More particularly, the present disclosure relates to an adjustable handle mechanism for use with a cooking implement, such as a burger press. The adjustable handle mechanism improves cooking and storage both for cooking items and utensils. The handle is able to releasably lock into different angles and is able to fully collapse for storage purposes.

### BACKGROUND

Cooking items and utensils generally comprise of a solid non-adjustable handle which is fixed at a certain position. Such cooking items may be perceived as not user-friendly and can also limit performance under various cooking conditions. There is a general need for a cooking utensil that includes an adjustable handle and that allows for flexibility in the owner's choice of what type handle position may be used. The present disclosure describes unique handle arrangements that can be adjusted in a number of different user-friendly angles from upright to completely flat for flat pack storage.

### SUMMARY

According to an exemplary arrangement, an apparatus comprises a cooking implement having a first surface, a first locking mechanism and a second locking mechanism. The first locking mechanism is provided along the first surface of the cooking implement. A first handle support bar comprising a first end and a second end, the first end of the first handle support bar is pivotally attached to the first locking mechanism. A second handle support bar comprising a first end and a second end, the first end of the second handle support bar is pivotally attached to the second locking mechanism. The first handle support bar is removably lockable in one or more positions.

In an arrangement, a handle is positioned between the second end of the first handle support bar and the second end of the second handle support bar.

In an arrangement, a rotational stop is provided by the first locking mechanism, the rotational stop preventing a rotational movement of the first handle support bar. The first handle support bar may be removably lockable in a plurality of positions. In one arrangement, the rotational stop prevents the first handle support bar from rotating by more than about 135 degrees.

In one arrangement, a first locking bar comprises a first end and a second end. The first end of the first locking bar is removably engageable with the first locking mechanism. A second locking bar comprises a first end and a second end, the first end of the second locking bar is removably engageable with the second locking mechanism. The apparatus may include a biasing mechanism for biasing the first locking bar and the second locking bar to a handle. The first locking bar and the second locking bar may be operatively coupled to the handle by way of the biasing mechanism. The first end of the first locking bar may be removably engageable with at least one slot defined by the first locking mechanism. In one arrangement, the first end of the second locking bar is removably engageable with at least one slot defined by the second locking mechanism. In an arrangement, the first locking mechanism comprises a plurality of slots.

In one arrangement, the first end of the first handle support bar comprises a slot selector comprising a pin. When the first handle support bar is rotated, the pin of the slot selector may be rotated so that the pin removably engages a slot defined by the first locking mechanism. The first locking mechanism may comprise a plurality of slots.

In one arrangement, the first locking mechanism comprises a plurality of slots.

The apparatus may include a biased pin operatively coupled to a first end of the first handle support bar. In one arrangement, when the first handle support bar is rotated, the biased pin is rotated so that the biased pin removably engages the first locking mechanism. When the biased pin is rotated, the biased pin may be configured to removably engage a plurality of slots defined by the first locking mechanism.

In one arrangement, the cooking implement comprises a press plate. In another arrangement, the cooking implement comprises a cheese melt dome. In an alternative arrangement, the cooking implement comprises a pan lid.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 illustrates a perspective view of a cooking implement including an arrangement of a locking mechanism;

FIG. 2 illustrates a perspective view of a cooking implement including an alternative arrangement of a locking mechanism;

FIG. 3a is a close up view of the locking mechanism illustrated in FIG. 2;

FIG. 3b is a close up view of the locking mechanism illustrated in FIG. 3a;

FIG. 4a is a close up view of an alternative locking mechanism for use with a cooking implement, such as the cooking implement illustrated in FIG. 1;

FIG. 4b is a close up view of the alternative locking mechanism illustrated in FIG. 4a;

FIG. 5a is a close up view of an alternative locking mechanism for use with a cooking implement, such as the cooling implement illustrated in FIG. 1;

FIG. 5b is a close up view of the alternative locking mechanism illustrated in FIG. 5a;

FIG. 6a illustrates an apparatus comprising a locking mechanism, such as the locking mechanism illustrated in FIGS. 2-3;

FIG. 6b illustrates an apparatus comprising a locking mechanism, such as the locking mechanism illustrated in FIGS. 5a-5b;

FIG. 7a illustrates a perspective view of a cooking implement including an alternative arrangement of a locking mechanism in a first position;

FIG. 7b illustrates a perspective view of the cooking implement illustrated in FIG. 7a in a second position;

FIG. 7c illustrates a perspective view of a cooking implement illustrated in FIG. 7b in a third position; and

FIG. 7d illustrates another perspective view of the cooking implement illustrated in FIG. 7c.

### DETAILED DESCRIPTION

The following detailed description describes various features and functions of the disclosed systems and methods with reference to the accompanying figures. The illustrative system and method embodiments described herein are not meant to be limiting. It may be readily understood that certain aspects of the disclosed systems and methods can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

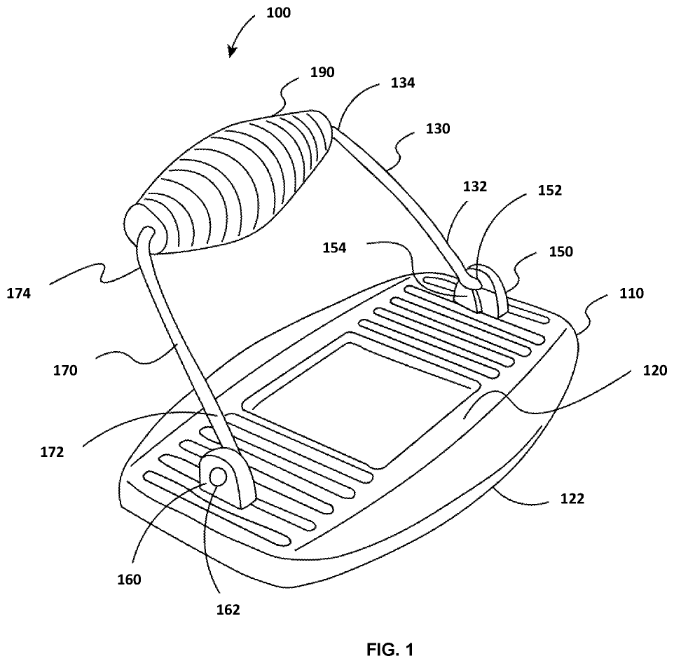

FIG. 1 illustrates a perspective view of an apparatus 100 for use with a cooking implement 110 wherein the apparatus 100 includes a locking mechanism 150. The apparatus 100 can further comprise a cooking implement 110 having a first surface 120. The cooking implement 110 further includes a second surface 122 opposite the first surface 120. The second surface 122 can be used to press upon a food product, such as a hamburger, sandwich (panini), or other similar food product that can be compressed while being heated.

As illustrated, the cooking implement 110 comprises a press plate. By press plate, it is meant to include a kitchen utensil designed to create meat patties that are consistent in shape, size and weight. As just one example, a typical burger press is made from plastic or stainless steel and consists of a container with a cover or “press” that can be forced downward against a ground meat to form it into a patty shape.

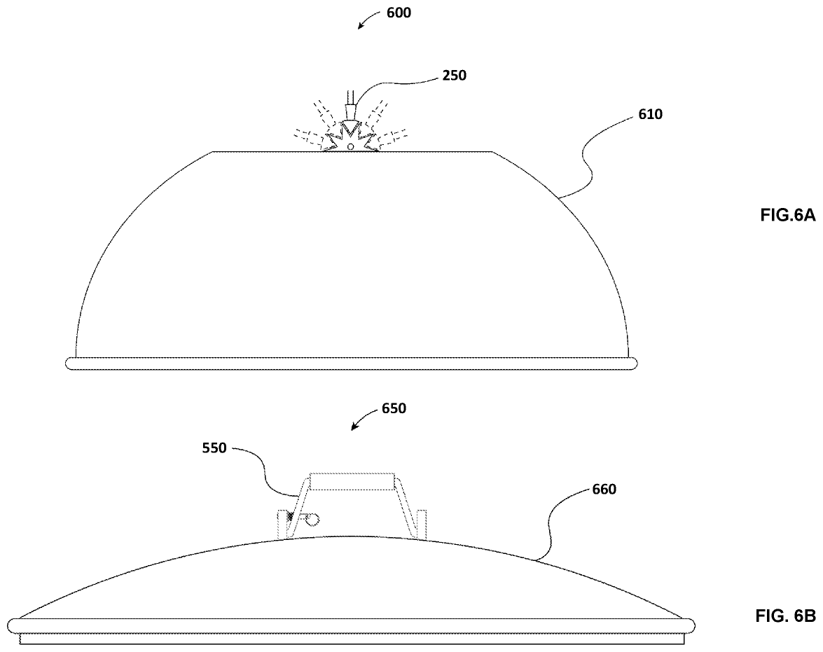

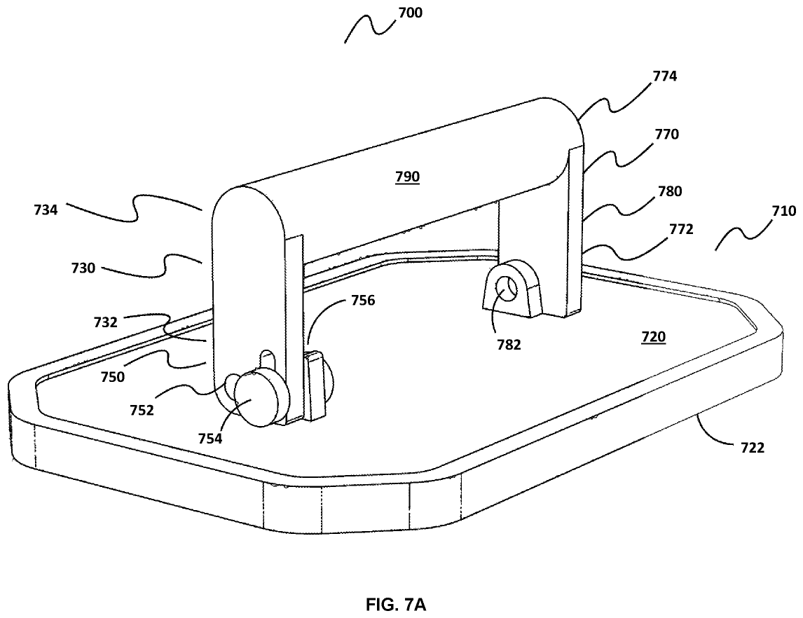

Alternatively, the cooking implement 110 may comprise a cheese melt dome such as the cheese melt dome 600 illustrated in FIG. 6a. In an alternative arrangement, the cooking implement 110 comprises a pan lid, such as the pan lid 650 illustrated in FIG. 6b.

Returning to FIG. 1, the apparatus 100 further comprises a first locking mechanism 150 and a second locking mechanism 180. The first locking mechanism 150 extends from the first surface 120 of the cooking implement and defines a first aperture 152. Similarly, the second locking mechanism 160 is provided along the first surface 120 of the cooking implement 110. The second locking mechanism 160 extends from the first surface 120 of the cooking implement and defines a first aperture 162.

The apparatus 110 further comprises a first handle support bar 130. This first handle support bar 130 comprises a first end 132 and a second end 134, the second end 134 being opposite the first end 132. The first end 132 of the first handle support bar 130 is pivotally attached to the first locking mechanism 150. Specifically, the first end 132 of the first handle support bar 130 is pivotally attached to the first locking mechanism 150 by rotationally engaging the aperture 152 defined by the first locking mechanism 150.

A second handle support bar 170 is similarly situated as the first handle support bar 130. For example, the second handle support bar 170 comprises a first end 172 and a second end 174, the second end 174 opposite the first end 172. The first end 172 of the second handle support bar 170 is pivotally attached to the second locking mechanism 160. Specifically, the first end 172 of the second handle support bar 170 is pivotally attached to the second locking mechanism 160 by rotationally engaging the aperture 162 defined by the second locking mechanism 160.

In this illustrated arrangement, the first handle support bar 130 of the apparatus 100 is releasably lockable in one or more positions. For example, the first locking mechanism 150 may comprise a rotational stop 154. This rotational stop 154 prevents or stops the handle support bars 130, 170 from moving beyond a certain angle of rotation. For example, the rotational stop 154 may be configured so as to prevent the handle support bars 130, 170 from moving beyond a defined number of degrees. In one arrangement, the rotational stop 154 prevents the handle support bars 130, 170 from rotating by more than about 135 degrees. As those of ordinary skill in the art will recognize, alternative rotational stop configurations may also be used. As just one example, a rotational stop may be provided by way of the second locking mechanism 160.

The apparatus 100 further comprises a handle 190 that is positioned between the second end of the first handle support bar 130 and the second end of the second handle support bar 170.

In this manner, a user of apparatus 100 can utilize the handle 190 to rotate the handle support bars 130, 170 to a final stop position allowed by the rotational stop 154 as illustrated in FIG. 1. A user can then use the apparatus 100 to press or process a food product, such as a hamburger or other similar compressible food product. Then, when the apparatus 100 is to be stowed or stored after use, the handle support bars 130, 170 can be rotated to a flat position where the handle support bars 130, 170 lay flat or substantially horizontal to the first surface 120 of the cooking implement 110.

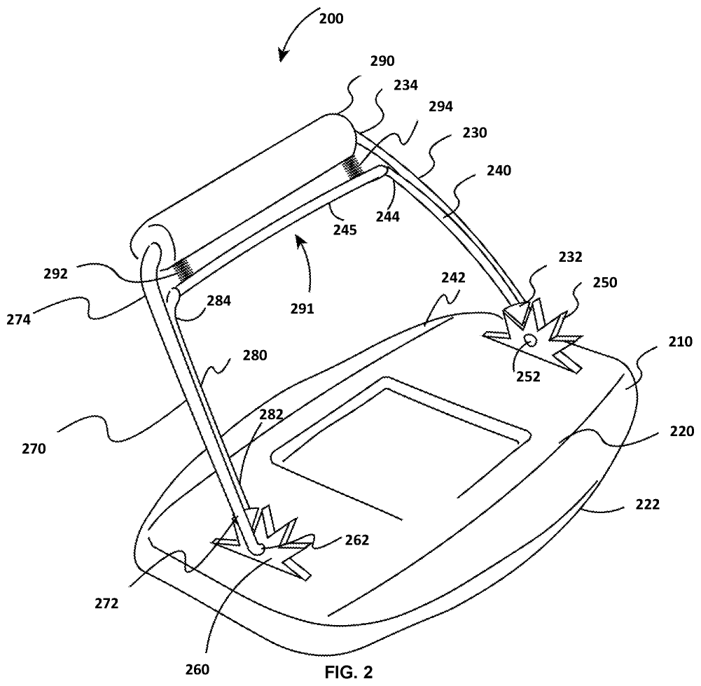

FIG. 2 illustrates a perspective view of an alternative apparatus 200 for use with a cooking implement 210 wherein the apparatus 200 includes a first locking mechanism 250. The apparatus 200 can further comprise a cooking implement 210 having a first surface 220. The cooking implement 210 further includes a second surface 222 opposite the first surface 220. The second surface 222 can be used to press upon a food product, such as a hamburger, sandwich (panini), or other similar food product that can be compressed while being heated.

As illustrated, the cooking implement 210 comprises a press plate. By press plate, it is meant to include a kitchen utensil designed to create meat patties that are consistent in shape, size and weight. As just one example, a typical burger press is made from plastic or stainless steel and consists of a round container with a circular cover or “press” that can be forced downward against a ground meat to form it into a patty shape.

Alternatively, the cooking implement 210 may comprise a cheese melt dome such as the cheese melt dome 600 illustrated in FIG. 6a. In an alternative arrangement, the cooking implement 110 comprises a pan lid, such as the pan lid 650 illustrated in FIG. 6b.

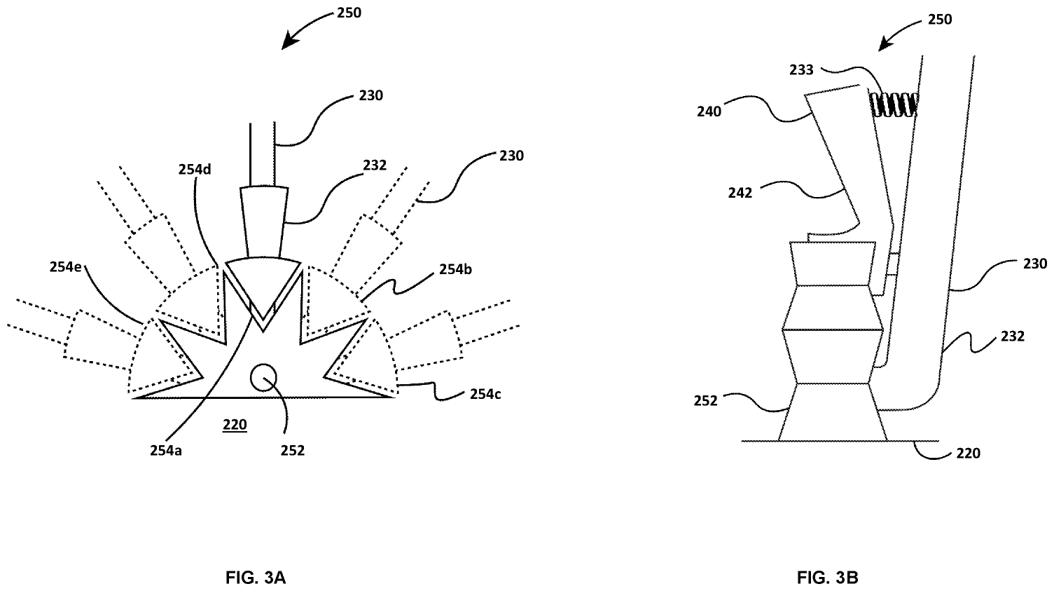

Returning to FIG. 2, the apparatus 200 further comprises a first locking mechanism 250 and a second locking mechanism 260. For example, FIG. 3a is a close up view of the first locking mechanism 250 illustrated in FIG. 2 and FIG. 3b is an alternative close up view of the first locking mechanism 250 illustrated in FIG. 3a.

Referring to FIGS. 2, 3a, and 3b, the first locking mechanism 250 extends from the first surface 220 of the cooking implement and defines a first aperture 252. Similarly, the second locking mechanism 260 is provided along the first surface 220 of the cooking implement 210. The second locking mechanism 260 extends from the first surface 220 of the cooking implement and also defines a first aperture 262.

The apparatus 210 further comprises a first handle support bar 230. This first handle support bar 230 comprises a first end 232 and a second end 234, the second end 234 being opposite the first end 232. The first end 232 of the first handle support bar 230 is pivotally attached to the first locking mechanism 250. Specifically, the first end 232 of the first handle support bar 230 is pivotally attached to the first locking mechanism 250 by rotationally engaging the aperture 252 defined by the first locking mechanism 250.

As illustrated in FIG. 2, second handle support bar 270 is similarly situated as the first handle support bar 230. For example, the second handle support bar 270 comprises a first end 272 and a second end 274, the second end 274 is opposite the first end 272. The first end 272 of the second handle support bar 270 is pivotally attached to the second locking mechanism 260. Specifically, the first end 272 of the second handle support bar 270 is pivotally attached to the second locking mechanism 260 by rotationally engaging the aperture 262 defined by the second locking mechanism 260.

In this illustrated arrangement, the apparatus 200 further comprises a first locking bar 240 and this first locking bar comprises a first end 242 and a second end 244. As illustrated in FIG. 2, the first locking bar 240 is adjacent the first handle support bar 230. A first end 242 of the first locking bar 240 is removably engageable with the first locking mechanism 250. In one arrangement, as illustrated in FIG. 3b, a spring 233 may be used to couple the first locking bar 240 to the first handle support bar 230.

Similarly, the apparatus 200 further includes a second locking bar 280 that comprises a first end 282 and a second end 284. The first end 282 of the second locking bar 280 is also removably engageable with the second locking mechanism 260.

As illustrated, the first locking mechanism 250 comprises at least on slot 254a. For example, referring to FIG. 3a, the first locking mechanism 250 comprises a plurality of slots 254a-e. In this illustrated arrangement, the first locking mechanism 250 comprises five slots. As illustrated, the first locking mechanism 250 comprises five slots 254a-e wherein the first end 242 of the first locking bar 240 is removably engageable with at least one slot defined by the first locking mechanism 250. For example, FIG. 3a illustrates where the first end 232 of the first locking bar 240 is releasably engaged the plurality of slots 254a-e defined by the locking mechanism 250. As those of ordinary skill in the art will recognize, alternative slot configurations may also be utilized.

Similarly, as illustrated in FIG. 2, the second locking mechanism 260 comprises at least on slot. As illustrated, the second locking mechanism 260 comprises five slots 274 a-e wherein the first end 272 of the second locking bar 270 is removably engageable with at least one slot defined by the second locking mechanism 260.

The apparatus 200 comprises a handle 290 that is positioned between the second end of the first handle support bar 230 and the second end of the second handle support bar 270.

The apparatus 200 further comprises a biasing mechanism 292 for biasing the first locking bar 240 and the second locking bar 280 to a handle 290. Specifically, the biasing mechanism 291 biases a horizontal locking bar 245 that operatively couples the first locking bar 240 and the second locking bar 280 to the handle 290. In this illustrated arrangement, the biasing mechanism comprises a first spring 292 and a second spring 294 wherein the first locking bar 240 and the second locking bar 280 are operatively coupled to the handle 290 by way of the biasing mechanism. The two springs 292, 294 of the biasing member 291 operatively engage the horizontal locking bar 245.

In this manner, a user of apparatus 200 can utilize the handle 290 and hence the horizontal locking bar 245 to rotate the handle support bars 230, 270. By gripping the handle and the locking bar 245, the user can grip the horizontal bar 245 which would then disengage the first ends 242, 282 of the first and second bars 240, 280 respectively, allowing the apparatus 200 to rotate and then release the horizontal locking bar 245 so as to select one of the plurality of slots in the first locking mechanism 250 and the second locking mechanism 260.

A user can then use the apparatus 200 to press or process a food product, such as a hamburger or other similar compressible food product. Then, when the apparatus 200 is to be stowed or stored after use, the handle support bars 230, 270 and the locking bars 240, 280 can be rotated to a flat position where the handle support bars 230 270 and locking bars 240, 280 lay flat or substantially horizontal to the first surface 220 of the cooking implement 210.

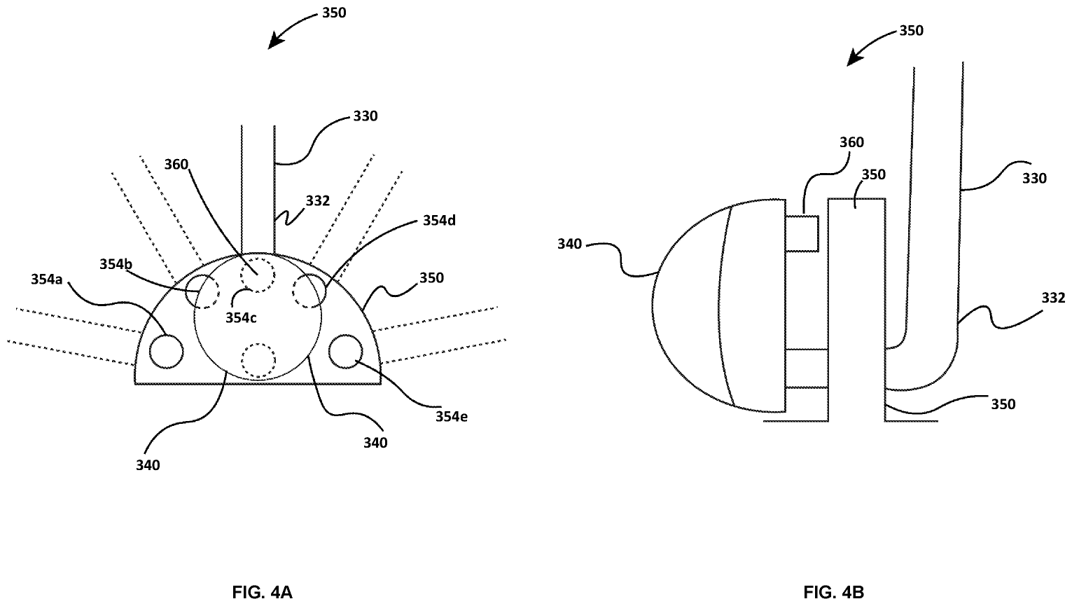

FIG. 4a illustrates a perspective view of an alternative locking mechanism 350 that may be used with a cooking implement, such as the cooking implement illustrated in FIG. 1 and FIGS. 2-3a,b. FIG. 4b illustrates another perspective view of the locking mechanism 350 illustrated in FIG. 4a.

As illustrated, the first locking mechanism 350 comprises at least on aperture 354a. In this locking mechanism embodiment, a first end 332 of a first handle support bar 330 is operatively coupled to a slot selector 340. And this slot selector 340 comprises a pin 360. In one arrangement, the first end 332 of the first handle support bar 330 passes through an aperture defined by the first locking mechanism 350. The end of the first handle support bar 330 that passes through this aperture is operatively coupled to the slot selector 340.

For example, referring to FIG. 4a, the first locking mechanism 350 comprises a plurality of apertures 354a-e. In this illustrated arrangement, the first locking mechanism 350 comprises five apertures. As illustrated, the first locking mechanism 350 comprises five apertures 354a-e wherein the pin 360 of the first slot selector 340 is removably engageable with at least one of the apertures defined by the first locking mechanism 350. For example, FIG. 4a illustrates where the pin 360 of the slot selector 340 is releasably engaged to the plurality of apertures 354a-e defined by the locking mechanism 350. As those of ordinary skill in the art will recognize, alternative aperture configurations may also be utilized.

In use, when the first handle support bar 330 is rotated, the pin 360 of the slot selector 340 is rotated so that the pin 360 removably engages an aperture defined by the first locking mechanism 350.

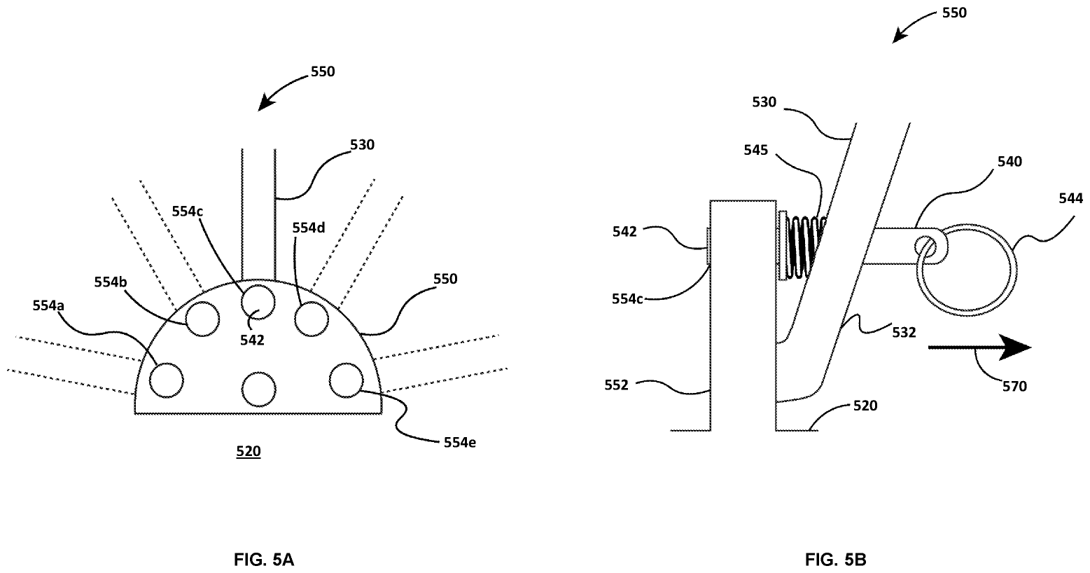

FIG. 5a illustrates a perspective view of an alternative locking mechanism 550 that may be used with a cooking implement, such as the cooking implements illustrated in FIG. 1 and FIGS. 2-3a,b. FIG. 5b illustrates another perspective view of the locking mechanism 550 illustrated in FIG. 5a.

Referring now to FIGS. 5a and 5b, the first locking mechanism 550 extends from a first surface 520 of a cooking implement and comprises at least on aperture 554a. In this locking mechanism embodiment, a first end 532 of a first handle support bar 530 is pivotally coupled to the first locking mechanism. In one arrangement, the first end 532 of the first handle support bar 530 is pivotally coupled to an aperture 552 defined by the first locking mechanism 550.

In addition, a first end 532 of the first handle support bar 530 includes a biased pin 540. The biased pin 540 is operatively coupled to the first end 532 of the first handle support bar 530. And this biased pin 540 is operatively coupled to at least one aperture 554a-e defined by the first locking mechanism 550. The biased pin 540 comprises a pin that is biased by a spring 545. In this manner, a distal portion 542 of the pin 540 releasably engages at least one aperture 554a-e defined by the locking mechanism 550.

For example, referring to FIG. 5a, the first locking mechanism 550 comprises a plurality of apertures 554a-e. In this illustrated arrangement, the first locking mechanism 550 comprises five apertures. As illustrated, the first locking mechanism 550 comprises five apertures 554a-e wherein the biased pin 540 can be pulled in direction noted by arrow 570, away from the first locking mechanism 550 and against a force created by the spring 545. As such, the biased pin 540 can be released from one of the apertures 554a-e defined by the first locking mechanism 550 and previously selected by the user.

FIG. 5a illustrates where the biased pin 540 is releasably engaged with the plurality of apertures 554a-e defined by the locking mechanism 550. As those of ordinary skill in the art will recognize, alternative aperture and/or biased pin configurations may also be utilized.

In use, when a user pulls a ring 544 that is coupled to the biased pin 540 in the direction of arrow 570, this will release the biased pin 540 from the aperture 554c. This releases the first handle support bar 530 and allows the first handle support bar 530 rotate. The biased pin 560 along with the first handle support bar 530 can then be rotated so that a user can release the biased pin 560 to removably engage one of the apertures 554a-e defined by the first locking mechanism 550.

FIG. 6a illustrates an apparatus 600 comprising a locking mechanism, such as the locking mechanism 250 illustrated in FIGS. 2 and 3a-b. Specifically, FIG. 6a illustrates the locking mechanism 250 for use on a cheese melt dome 610. FIG. 6b illustrates an apparatus 650 comprising a locking mechanism, such as the locking mechanism 550 illustrated in FIGS. 5a-5b. Specifically, FIG. 6a illustrates the locking mechanism 550 for use on a pan lid 660.

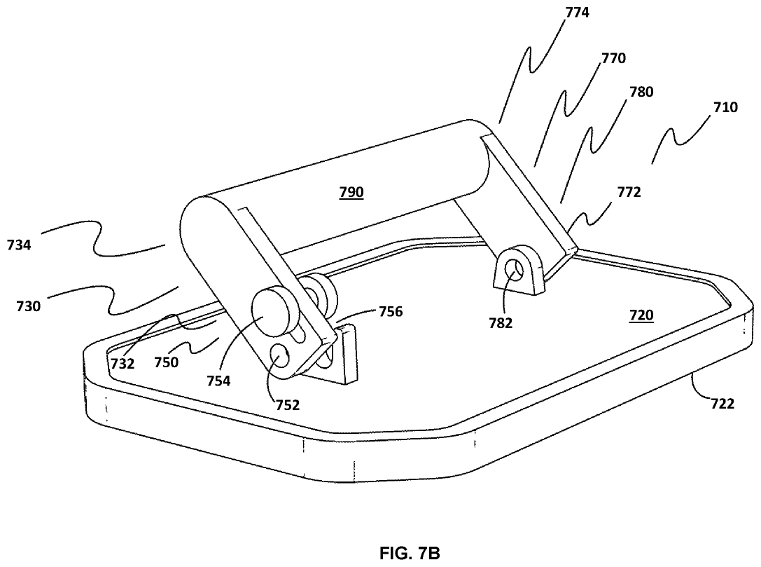

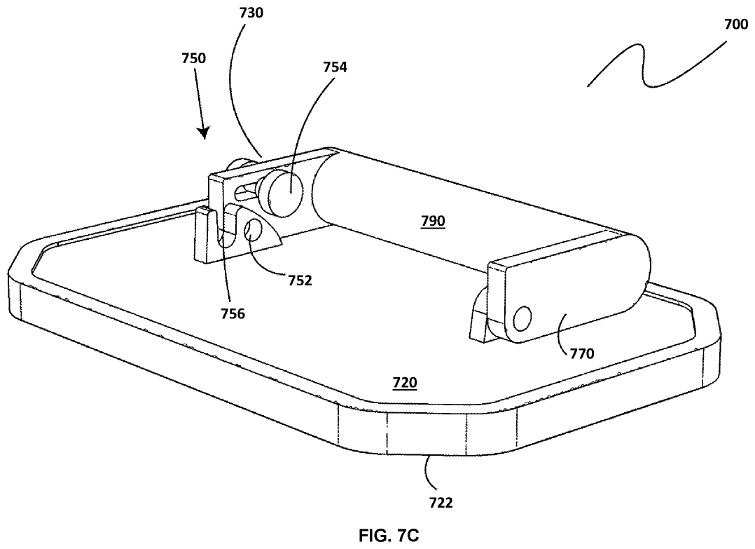

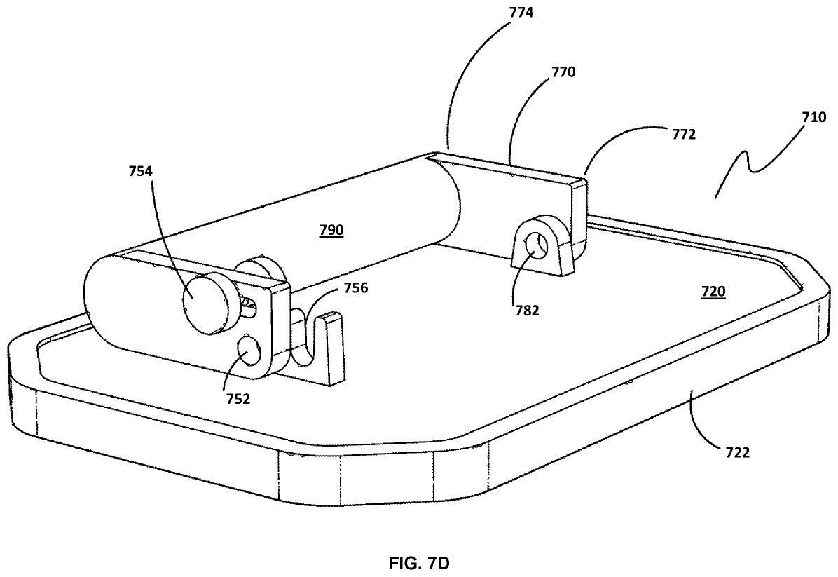

FIG. 7a illustrates a perspective view of an apparatus 700 for use with a cooking implement 710 wherein the apparatus 700 includes a locking mechanism 750. The apparatus 700 can further comprise a cooking implement 710 having a first surface 720. The cooking implement 710 further includes a second surface 722 opposite the first surface 720. The second surface 722 can be used to press upon a food product, such as a hamburger, sandwich (panini), or other similar food product that can be compressed while being heated.

As illustrated, the cooking implement 710 comprises a press plate. Alternatively, the cooking implement 710 may comprise a cheese melt dome such as the cheese melt dome 600 illustrated in FIG. 6a. In an alternative arrangement, the cooking implement 110 comprises a pan lid, such as the pan lid 650 illustrated in FIG. 6b.

Returning to FIG. 7a, the apparatus 700 further comprises a first locking mechanism 750 and a second locking mechanism 780. The first locking mechanism 750 extends from the first surface 720 of the cooking implement and defines a first aperture 752. Similarly, the second locking mechanism 780 is provided along the first surface 720 of the cooking implement 710. The second locking mechanism 780 extends from the first surface 720 of the cooking implement and defines a first aperture 782.

The apparatus 710 further comprises a first handle support bar 730. This first handle support bar 730 comprises a first end 732 and a second end 734, the second end 734 being opposite the first end 732. The first end 732 of the first handle support bar 730 is pivotally attached to the first locking mechanism 750. Specifically, the first end 732 of the first handle support bar 730 is pivotally attached to the first locking mechanism 750 by rotationally engaging the aperture 752 defined by the first locking mechanism 750.

A second handle support bar 770 is similarly situated as the first handle support bar 730. For example, the second handle support bar 770 comprises a first end 772 and a second end 774, the second end 774 opposite the first end 772. The first end 772 of the second handle support bar 770 is pivotally attached to the second locking mechanism 760. Specifically, the first end 772 of the second handle support bar 770 is pivotally attached to the second locking mechanism 760 by rotationally engaging the aperture 762 defined by the second locking mechanism 760.

In this illustrated arrangement, the first handle support bar 730 of the apparatus 700 is releasably lockable in one or more positions. For example, the first locking mechanism 750 may comprise a slidable bolt 754. This slidable bolt 754 prevents or stops the handle support bars 730, 770 from moving when the slidable bolt 754 resides in a locked position (FIG. 7a). In this locked position, the slidable bolt 754 engages a friction fit 756 defined by the first locking mechanism 750. When slid to engage this friction fit 756, the slidable bolt 754 will be retained within the first locking mechanism 750. The apparatus 700 further comprises a handle 790 that is positioned between the second end 734 of the first handle support bar 730 and the second end 774 of the second handle support bar 770.

In this manner, a user of apparatus 700 can utilize the handle 790 to rotate the handle support bars 730, 770 to a final locked position as illustrated in FIG. 7a. A user can then use the apparatus 700 to press or process a food product, such as a hamburger or other similar compressible food product. Then, when the apparatus 700 is to be stowed or stored after use, the slidable bolt 754 can be slid to an unlocking position. For example, FIG. 7b illustrates a perspective view of the cooking implement illustrated in FIG. 7a with the bolt 745 now moved into an unlocked or a second position, thereby allowing rotation of the first and second handle support bars 730, 770.

With the slidable bolt 745 now in an unlocking position, the handle support bars 730, 770 can be rotated to a flat position where the handle support bars 730, 770 lay flat or substantially horizontal to the first surface 720 of the cooking implement 710. For example, FIG. 7c illustrates a perspective view of the cooking implement 710 illustrated in FIG. 7b in a flat position. FIG. 7d illustrates another perspective view of the cooking implement 710 illustrated in FIG. 7c.

The description of the different advantageous embodiments has been presented for purposes of illustration and description, and is not intended to be exhaustive or limited to the embodiments in the form disclosed. Modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

I claim:

1. An apparatus, comprising:
a cooking implement having a first surface;
a first locking mechanism and a second locking mechanism, the first locking mechanism provided along the first surface of the cooking implement;
a first handle support bar comprising a first end and a second end, the first end of the first handle support bar pivotally attached to the first locking mechanism;
a second handle support bar comprising a first end and a second end, the first end of the second handle support bar pivotally attached to the second locking mechanism,
wherein the first handle support bar is removably lockable in one or more positions.

2. The apparatus of claim 1, further comprising:
a handle positioned between the second end of the first handle support bar and the second end of the second handle support bar.

3. The apparatus of claim 1, further comprising:
a rotational stop provided by the first locking mechanism, the rotational stop preventing a rotational movement of the first handle support bar.

4. The apparatus of claim 3, wherein
the first handle support bar is removably lockable in a plurality of positions.

5. The apparatus of claim 3, wherein:
the rotational stop prevents the first handle support bar from rotating by more than about 135 degrees.

5. The apparatus of claim 1, further comprising:
a first locking bar comprising a first end and a second end, the first end of the first locking bar removably engageable with the first locking mechanism, and
a second locking bar comprising a first end and a second end, the first end of the second locking bar removably engageable with the second locking mechanism.

6. The apparatus of claim 5, further comprising
a biasing mechanism for biasing the first locking bar and the second locking bar to a handle.

7. The apparatus of claim 6 wherein
the first locking bar and the second locking bar are operatively coupled to the handle by way of the biasing mechanism.

8. The apparatus of claim 5, wherein
the first end of the first locking bar is removably engageable with at least one slot defined by the first locking mechanism.

9. The apparatus of claim 5, wherein
the first end of the second locking bar is removably engageable with at least one slot defined by the second locking mechanism.

10. The apparatus of claim 5, wherein
the first locking mechanism comprises a plurality of slots.

11. The apparatus of claim 1, wherein
the first end of the first handle support bar comprises a slot selector comprising a pin.

12. The apparatus of claim 11, wherein
when the first handle support bar is rotated, the pin of the slot selector is rotated so that the pin removably engages a slot defined by the first locking mechanism.

13. The apparatus of claim 12, wherein
the first locking mechanism comprises a plurality of slots.

14. The apparatus of claim 1, wherein
the first locking mechanism comprises a plurality of slots.

15. The apparatus of claim 15, further comprising:
a biased pin operatively coupled to a first end of the first handle support bar.

16. The apparatus of claim 14, wherein
when the first handle support bar is rotated, the biased pin is rotated so that the biased pin removably engages the first locking mechanism.

17. The apparatus of claim 16, wherein
when the biased pin is rotated, the biased pin is configured to removably engage a plurality of slots defined by the first locking mechanism.

18. The apparatus of claim 1, wherein
the cooking implement comprises a press plate.

19. The apparatus of claim 1, wherein
the cooking implement comprises a cheese melt dome.

20. The apparatus of claim 1, wherein
the cooking implement comprises a pan lid.
